(19) United States
(12) Patent Application Publication
(10) Pub. No.: US 2007/0025230 A1
(43) Pub. Date: Feb. 1, 2007

(54) Compensation methods based on laser diode controlling input

(75) Inventor: Chih-Hao Chang, Fongyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/189,516

(22) Filed: Jul. 26, 2005

(51) Int. Cl. G11B 7/00

(52) U.S. Cl. 369/116

(57) ABSTRACT

Methods for system parameter compensation and temperature detection based on a controlling input of a laser diode (LD). The controlling input of the LD is measured and compared with a reference value measured at a known environment. The comparison result is used to tune a system parameter of an optical disc drive in order to compensate for system deviation or performance degradation due to environmental variation.

### BACKGROUND

The invention relates to compensation methods, and more specifically, to methods for tuning a system parameter using laser diode controlling input to compensate for performance variation due to changes in surrounding environment.

Optical disc drives capable of reproducing and recording data on an optical disc may operate under various circumstances or applications at an environment significantly different from a normal condition. Among many environmental factors that may affect the system operation, temperature variation contributes a noticeable effect on component characteristics. For example, with the increasing popularity of miniature computers such as notebooks, the optical disc drives that are mounted in such devices are thinner. The trend of reducing the device size of the optical disc drives implies that the components are arranged more densely in the drives, which makes it difficult to ensure proper internal cooling. The heat generated inside the drive may eventually raise the ambient temperature. On the contrary, the ambient temperature may drop due to overcooling. In an optical disc drive, many components and their characteristics behave and react, slightly different under various ambient temperatures. For example, the wavelength of the laser light emitted from a semiconductor laser chip is generally longer as temperature increases, and the laser power of a laser diode generally becomes getting weaker when the temperature increases.

Some system parameters of optical disc drives should adapt to the operating environment by compensating the behavior deviation or performance degradation caused by the change in environment. Providing a sensor or detector to the pick-up head may compensate for the system parameters by detecting, for example, the ambient temperature or humidity of the system and then tuning these system parameters accordingly. Most optical disc drives, however, do not have such sensor operating with their pick-up head due to increased manufacturing costs.

An embodiment of an exemplary compensation method comprises measuring a controlling input of a laser diode, and tuning a system parameter by comparing the measured controlling input with at least a reference value. The controlling input of the laser diode corresponds to an input current or an input voltage for driving the laser diode or a laser diode driver. The reference value is measured at a known environment after calibrating and deriving a predetermined read power.

In some embodiments, the reference value is measured at predetermined temperature, humidity, and supply voltage.

The temperature detection method is applicable for optical disc drives such as compact disc (CD) drives, CD players, CD recorders, digital versatile disc (DVD) drives, DVD players, and DVD recorders.

The system parameter may comprise one or a combination of servo control parameter, write strategy parameter, write power level, sample and hold parameter, read power level, and maximum recording speed.

Temperature is one of the most significant factors for affecting the characteristic of electric components, thus present temperature can be derived by measuring a controlling input of the laser diode, and comparing with a reference value measured at known temperature. In some embodiments, an upper and a lower threshold are determined by the reference value, and the present temperature is classified as high temperature if it exceeds the upper threshold or as low temperature if it is below the lower threshold. The temperature detection method may be applied to compensate for system deviation or performance degradation caused by temperature variation once the present temperature is determined.

A power calibration method for an optical disc drive is also provided. Some embodiments comprise calibrating read power at a known environment, driving a laser diode to emit the calibrated read power, measuring a controlling input of the laser diode as a reference value, and storing the reference value in a memory. The reference value corresponds to the known environment and can be read out for compensating for electric component characteristic due to temperature, humidity, or other environmental variations.

### DESCRIPTION OF THE DRAWINGS

The invention can be more fully understood by reading the subsequent detailed description in conjunction with the examples and references made to the accompanying drawings, wherein:

FIG. 1 is a graph of an exemplary LD read power versus LD driver output current Iₒ showing that the relationship between read power and output current Iₒ varies with temperature.

FIG. 2 shows an automatic power control (APC) loop in an optical disc drive for controlling the read power emitted by a LD.

FIG. 3 is a graph showing an exemplary relationship between VRDCO voltage and temperature.

FIG. 4 is a flowchart showing an embodiment of a power calibration method.

FIG. 5 is a flowchart showing an embodiment of a temperature detection method.

FIG. 6 shows an exemplary relationship of a ratio between VRDCO_M and VRDCO_N versus temperature.

FIG. 7 shows different boundaries required for regulating the sled control reference signal at normal operating temperature and a lower temperature.

### DETAILED DESCRIPTION

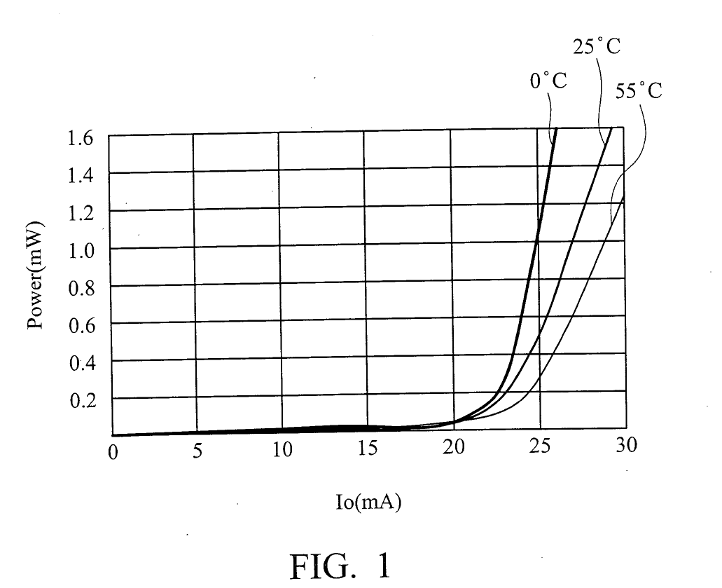

The compensation method allows the optical disc drive to automatically adjust the electric component parameters and settings to reduce the performance degradation due to change in the surrounding environment. The change in the surrounding environment is detected by measuring a controlling input, which is much cheaper than implementing a temperature or humidity sensor in the optical disc drive. The provided methods are capable of determining present system temperature without using a temperature sensor. Laser diodes (LD) behave slightly different at various surrounding environments, in which temperature has a noticeable influence, so that the ambient temperature can be estimated according to the change in the LD controlling input. FIG. 1 is a graph of an exemplary LD read power versus LD driver output current Iₒ showing the relationship between read power and output current Iₒ varies with temperature. Under the same read power, the output current Iₒ of the LD driver must be greater if the system is in a high temperature environment. For example, FIG. 1 shows that when the read power emitted by the laser diode is 1 mW, the LD driver output current Iₒ is around 25 mA at 0° C., and around 29 mA at 55° C.

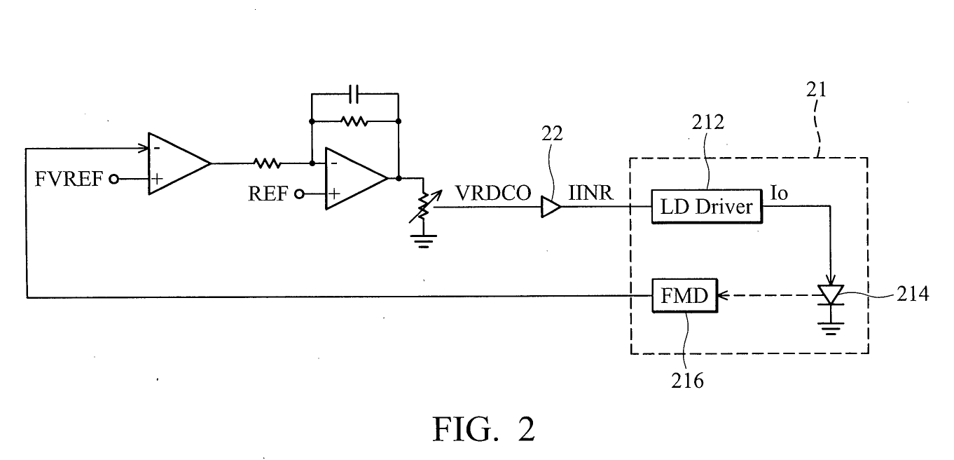

FIG. 2 shows an automatic power control (APC) loop in an optical disc drive for controlling the power emitted by a laser diode. A pick-up head (PUH) 21 in the APC loop comprises a laser diode (LD) driver 212, a LD 214, and a front monitor diode (FMD) 216. An input current IINR is provided to the LD driver 212 through an operational (OP) amplifier 22 to generate an output current Iₒ, and the output current drives the LD 214 to read or write an optical disc by emitting a laser beam. There is a positive correlation between the input voltage VRDCO of the OP amplifier 22, the input current IINR of the LD driver 212, and the output current Iₒ of the LD driver 212. FIG. 1 shows that during experiments, the relationship of read power and output current Iₒ is dependent on the temperature. This implies that VRDCO and IINR behave in a similar manner with respect to the read power. Under the same read power, the output current Iₒ at high temperature is greater than Iₒ at room temperature (around 25° C.), and Iₒ at room temperature is greater than Iₒ at low temperature. Similarly, both VRDCO and IINR are also greater at higher temperature when the read power is the same.

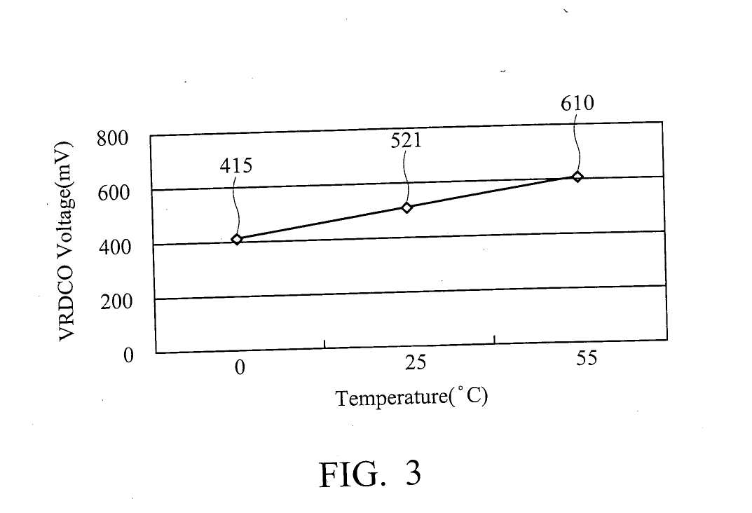

In practice, it is more difficult to measure the output current Iₒ and the input current IINR of the LD driver 212 compared to the input voltage VRDCO, thus, in some embodiments, the ambient temperature is determined according to a relative measurement of VRDCO rather than Iₒ or IINR. FIG. 3 is a graph of VRDCO voltage versus temperature showing an exemplary relationship derived by conducting an experiment. The measured value of VRDCO increases with temperature from 415 mV at 0° C. to 610 mV at. 55° C.

In the following, the voltage VRDCO is used as an index for determining temperature, or an index for compensating for one or more system parameters, it is not however limited to this, since other measurements such as current Iₒ and IINR responsive to the LD are also applicable for temperature determination and system compensation.

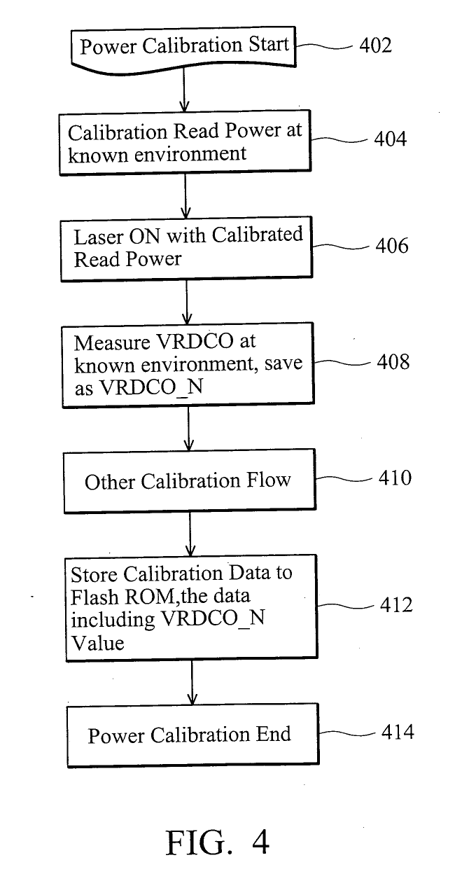

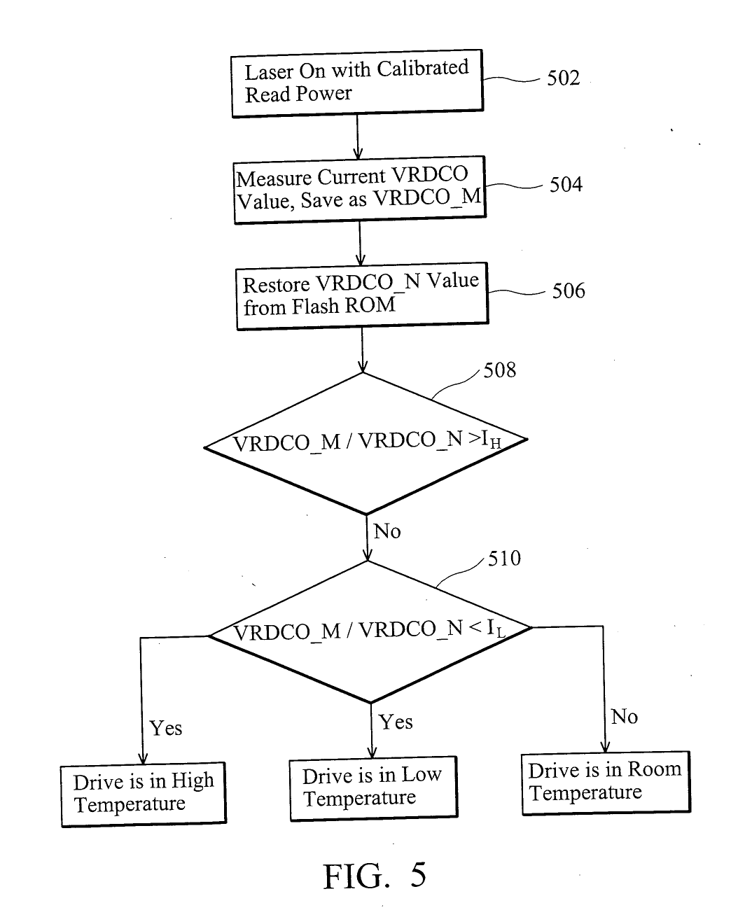

In some embodiments, the system measures the voltage VRDCO at one or more known environment, and stores the measurement in a memory as reference for temperature determination or system parameter compensation. If more than one measurements corresponding to various known environments are stored, the temperature may be determined by searching or calculating with an interpolation algorithm. FIGS. 4 and 5 illustrate embodiments with a simple implementation, where only one reference value is obtained by measuring VRDCO at a known environment, for example, at normal operating temperature and humidity.

FIG. 4 is a flowchart showing an embodiment of a power calibration method. In Steps 402 and 404, an optical disc drive is placed at a known environment, and the read power is calibrated at the known environment. In Step 406, the LD emits the calibrated read power after completing the power calibration. In Step 408, the system measures a stable VRDCO value corresponding to the known environment, which is saved as VRDCO_N to serve as a reference value for temperature determination or system parameter calibration. In some embodiments, the known environment refers to normal operating temperature such as 20° C. to 30° C., humidity, and supplying voltage. After completing the power calibration process of Step 410, the calibration data including VRDCO_N is stored in a Flash ROM in Step 412.

FIG. 5 is a flowchart showing an embodiment of a temperature detection method. The optical disc drive is turned on and operated at an unknown temperature, and the firmware is capable of determining the current temperature based on the change in VRDCO. In Step 502, the optical disc drive starts up and reads data recorded on the optical disc by emitting the calibrated read power. The system measures and saves a stable VRDCO value as VRDCO_M in Step 504, and it compares VRDCO_M with VRDCO_N stored in the Flash ROM during power calibration (Steps 508 and 510). If a ratio between the current VRDCO value VRDCO_M and the reference VRDCO value VRDCO_N is greater than an upper threshold I_{H}, the current temperature of the optical disc drive is determined as high temperature. On the other hand, if the ratio between VRDCO_M and VRDCO_N is less than a lower threshold I_{L}, the current temperature is determined as low temperature. The optical disc drive is determined as currently at normal operating temperature if VRDCO_M is relatively close to VRDCO_N.

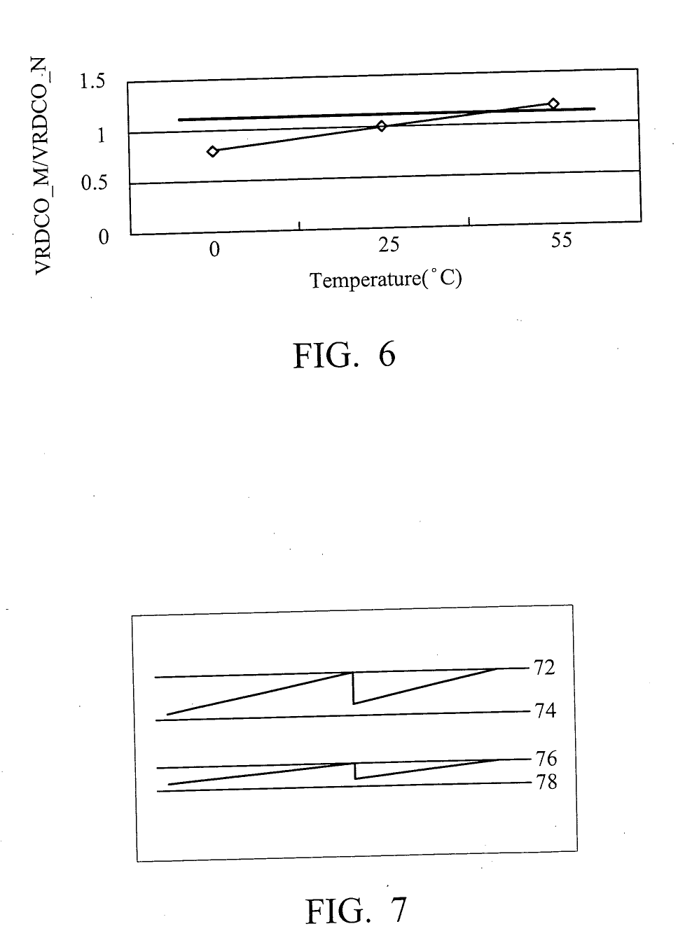

FIG. 6 shows an exemplary relationship of a ratio between VRDCO_M and VRDCO_N versus temperature. The system is located at a temperature higher than the normal operating temperature (for example, room temperature) if the ratio VRDCO_M/VRDCO_N is greater than 1, conversely, the system is at a temperature lower than the normal operating temperature if VRDCO_M/VRDCO_N is less than 1. In order to consider the bias induced from the ambient environment during measurement, an upper threshold slightly greater than 1 and a lower threshold slightly less than 1 are set as the thresholds for temperature determination. As shown in FIG. 6, the upper threshold I_{H} and lower threshold IL may be set as 1+10% and 1−10% respectively. The ambient temperature is determined as high temperature when the ratio VRDCO_M/VRDCO_N exceeds I_{H}, and low temperature when the ratio VRDCO_M/VRDCO_N is less than I_{L}. The temperature determination result may be used for compensating changes in various system characteristics affected by the ambient temperature.

In some embodiments, a compensation method tunes a system parameter of an optical disc drive according to a measured controlling input of a laser diode. The measured controlling input may be VRDCO or any measurement that reflects the operating characteristic of the laser diode. The system may issue an interrupt for compensating the system parameters when detecting a significant change in the laser diode controlling input. Embodiments of the compensation method are capable of determining the type of environmental change based on the comparing result, for example, a significant increase in VRDCO value may indicate overheating in the disc drive. The system parameters can thus be tuned accordingly. The following description lists a number of system parameters that can be tuned according to embodiments of the compensation method.

When the optical disc drive is operated in track following, a tracking error control signal output (TRO) or a center error control signal output (CSO) is used as the reference signal for controlling the sled movement. As shown in the upper section of FIG. 7, an upper threshold 72 and lower threshold 74 are set as a boundary for sled control at normal operating temperature. A control effect is applied to the sled when the reference signal touches the boundary, in order to keep the lens positioned at the center of a pick-up head. The gain diminishes due to the change of the OEIC characteristic at low temperature, causing a reduction in change of the reference signal responsive to the lens shifts away from the center of the pick-up head. The boundary set by the upper and lower thresholds must be narrower to maintain a similar control effect to correct the shift. The gain is less at low temperature, so that a larger lens shift is obtained by applying the same amount of voltage deviation. As shown in the lower section of FIG. 7, a narrower boundary set by an upper threshold 76 and a lower threshold 78 is required to achieve similar sled control. The boundary for regulating the sled control reference signal is thus controlled by tuning a stepping motor parameter in accordance with the controlling input of the laser diode.

In some embodiments, the comparing result of the laser diode controlling input can be used to tune or select servo control parameters such as servo equalizer coefficients, servo gains, and sled parameters for tracking and/or focusing control.

The response of the FPDO and laser diode is slightly different at various environments when the laser diode is in a write mode. The FPDO and laser diode responses influence the behavior of the APC loop. Parameters corresponding to the write strategy and write power may be tuned according to the measured controlling input of the laser diode. The write strategy and write power control the pulse shape for turning the power on or off to form recording marks on an optical disc for data recording. Tuning those parameters compensates for the write strategy and write power to eventually achieve an optimized write quality at the present operating environment.

Settings for sample and hold also require temperature or other environmental compensation to achieve better performance for disc recording. The sample and hold parameters may comprise read power sample and hold parameters, wobble signal sample and hold parameters, servo sample and hold parameters, and write power sample and hold parameters. These sample and hold parameters control the timing for obtaining valid samples, for example, the read power sample and hold parameters define a sampling period within the period of a land marking on the optical disc. The system is only allowed to sample the read power within the sampling period. The sampling period may be defined by regulating the start and finish sampling time. The wobble signal is extracted from grooves of an optical disc, which carries coding information. For example, recording addresses may be obtained by decoding the groove wobble signal extracted from a recordable optical disc.

The system parameters tuned in accordance with the controlling input of the laser diode may comprise a read power level and a decision of the maximum speed for data recording. For example, if the ambient temperature is determined as high or low, the writing speed may be limited by decreasing the maximum recording speed to prevent poor quality of high speed recording in such severe environment.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A compensation method for tuning a system parameter of an optical disc drive, wherein the optical disc drive comprises a laser diode for emitting a laser beam onto an optical disc, the compensation method comprising:
measuring a controlling input of the laser diode; and
tuning the system parameter by comparing the measured controlling input with at least a reference value;
wherein each reference value is measured at a known environment.

2. The compensation method according to claim 1, wherein the controlling input corresponds to an input current of the laser diode or a laser diode driver for driving the laser diode.

3. The compensation method according to claim 1, wherein the controlling input corresponds to a voltage for driving a laser diode driver that drives the laser diode.

4. The compensation method according to claim 1, wherein a reference value reflects the controlling input of the laser diode at a combination of known temperature, humidity, or supply voltage.

5. The compensation method according to claim 1, further comprising:
measuring the controlling input of the laser diode at the known environment as the reference value; and
storing the reference value in a memory.

6. The compensation method according to claim 5, wherein the reference value is measured after deriving a predetermined read power during power calibration.

7. The compensation method according to claim 1, wherein the measured controlling input and the reference value correspond to the same power level emitted by the laser diode.

8. The compensation method according to claim 1, wherein the system parameter comprises a servo control parameter, a write strategy parameter, a write power level, a sample and hold parameter, a read power level, or a decision of maximum recording speed.

9. The compensation method according to claim 8, wherein the sample and hold parameter controls the timing for sampling a read power level, wobble signal, servo controlling signal, or write power level during recording.

10. A temperature detection method, comprising:
measuring a controlling input of a laser diode; and
determining present temperature by comparing the measured controlling input with a reference value;
wherein the reference value is measured at a known temperature.

11. The temperature detection method according to claim 10, wherein the controlling input corresponds to an input current or an input voltage for driving the laser diode.

12. The temperature detection method according to claim 10, wherein the reference value reflects the controlling input of the laser diode at a normal working temperature around 20° C. to 30° C.

13. The temperature detection method according to claim 12, wherein the present temperature is classified as high temperature if the ratio of the measured controlling input to the reference value is greater than an upper threshold, and the present temperature is classified as low temperature if the ratio of the measured controlling input to the reference value is less than a lower threshold, else the present temperature is classified as normal operating temperature.

14. The temperature detection method according to claim 10, wherein the present temperature is determined by matching the measured controlling input to a plurality of reference values corresponding to various known temperatures.

15. The temperature detection method according to claim 10, further comprising tuning a system parameter according to the determined present temperature for temperature-compensation.

16. The temperature detection method according to claim 15, wherein the system parameter comprises a servo control parameter, a write strategy parameter, a write power level, a sample and hold parameter, a read power level, or a maximum recording speed.

17. The temperature detection method according to claim 16, wherein the sample and hold parameter controls the timing for sampling a read power level, wobble signal, servo controlling signal, or write power level during recording.

18. A power calibration method for an optical disc drive, comprising:
calibrating read power at known environment;
driving a laser diode to emit the calibrated read power;
measuring a controlling input of the laser diode as a reference value; and
storing the reference value in a memory;
wherein the reference value is for compensating for electric component characteristic due to environmental changes.

19. The power calibration according to claim 18, wherein the controlling input corresponds to an input current or voltage for driving a laser diode driver.
